(19) United States
(12) Patent Application Publication
(10) Pub. No.: US 2024/0025794 A1
(43) Pub. Date: Jan. 25, 2024

(54) METHOD FOR OPTIMIZING PROPERTY PROFILES IN SOLID SUBSTRATE PRECURSORS

(71) Applicant: Heraeus Quarzglas GmbH & Co. KG, Hanau (DE)

(72) Inventor: Klaus BECKER, Hanau (DE)

(21) Appl. No.: 18/352,741

(22) Filed: Jul. 14, 2023

(30) Foreign Application Priority Data
Jul. 22, 2022 (EP) 22186404.4

(51) Int. Cl. C03C 3/06

(52) U.S. Cl. CPC C03C 3/06; C03C 2201/42; C03C 2203/10

(57) ABSTRACT

A method for producing a substrate precursor having a mass of more than 100 kg, comprising a TiO2-SiO2 mixed glass, comprising the steps including:

introducing a silicon dioxide raw material and a titanium dioxide raw material into a flame,

producing a glass body having a titanium dioxide content of 3 wt. % up to 10 wt. %, the glass body comprising:

a macroscopic, production-related titanium profile, and

a microscopic, production-related layer structure,

dividing the glass body into a plurality of rod-like glass body portions,

spatially measuring the titanium profile in each of the glass body portions,

connecting the glass body portions to form an elongate first glass component,

first homogenization treatment of the first glass component,

pushing together the first glass component to create a spherical glass system,

turning the glass system more than 70 degrees,

and stretching the glass system.

### CROSS-REFERENCE TO RELATED APPLICATIONS

This application claims priority pursuant to 35 U.S.C. 119(a) to European Application No. 22186404.4, filed Jul. 22, 2022, which application is incorporated herein by reference in its entirety.

### BACKGROUND OF THE INVENTION

The invention relates to a method for producing a substrate precursor having a mass of more than 50 kg, in particular more than 100 kg, comprising a TiO2-SiO2 mixed glass.

### PRIOR ART

EP2960219A1 describes that, in EUV lithography, highly integrated structures having a line width of less than 50 nm are generated by means of microlithographic projection devices. Typically, working radiation from the spectral range between 10 nm and 121 nm is used, which is referred to as EUV range (extreme ultraviolet light, also known as “soft X-ray radiation”).

The projection devices are equipped with mirror elements which consist substantially of synthetic high-silica quartz glass doped with titanium dioxide (also referred to below as “TiO2-SiO2 mixed glass” or “TiO2-SiO2 glass”) and are provided with a reflective layer system. The TiO2-SiO2 mixed glass is characterized by an extremely low coefficient of thermal expansion (hereinafter also referred to as “CTE”). CTE is a glass property which depends on the thermal history of the glass and some other parameters but primarily on the titanium dioxide concentration.

The substrate precursor of TiO2-SiO2 mixed glass is mechanically processed to form the mirror substrate and is mirrored to form a mirror element.

As a result of the constantly increasing demands on the line widths to be achieved, the demands on the TiO2-SiO2 mixed glass also rise. In order to achieve the smaller line widths, the EUV source powers are frequently increased. This increase in the EUV power leads firstly to a higher throughput of the steppers but also to greater heating of the mirrors. Consequently, minors which are ever more homogeneous and more defined are required since the imaging errors otherwise increase with the source powers.

In addition, ever smaller structural widths require better imaging properties per se. In this case, the numerical aperture is of particular significance. The optical opening angle of the mirror objective is directly related to the optical resolution. A higher numerical aperture (i.e., a higher beam angle) allows a better resolution. However, this requires larger mirror substrates.

For production-related reasons, TiO2-SiO2 mixed glass comprises a microscopic layer structure. JP2006240979A describes a method for reducing this layer structure. It has been found to be disadvantageous that, in the production of a substrate precursor having a desired mass of more than 100 kg, a macroscopic, production-related titanium profile also occurs in addition to the microscopic, production-related layer structures. This production-related titanium profile influences the quality of the final substrate precursor and is not eliminated by the known methods.

### TECHNICAL OBJECT

In general, it is an object of the present invention to at least partially overcome a disadvantage resulting from the prior art. Another object of the invention is to provide a substrate precursor in which the influences of the macroscopic, production-related titanium profiles are reduced. It is also an object of the invention to provide a substrate precursor in which the influences of the macroscopic, production-related property profiles are reduced. It is also an object of the invention to provide a substrate precursor having a mass of more than 50 kg, in particular more than 100 kg, by means of which a high numerical aperture is achieved.

### PREFERRED EMBODIMENTS OF THE INVENTION

The features of the independent claims contribute to at least partially fulfilling at least one of the aforementioned objects. The dependent claims provide preferred embodiments which contribute to at least partially fulfilling at least one of the objects.

|1| A method for producing a substrate precursor having a mass of more than 50 kg, comprising a TiO2-SiO2 mixed glass, comprising the steps of:

a. introducing a silicon dioxide raw material and a titanium dioxide raw material into a flame,

b. producing a glass body having a titanium dioxide content of 3 wt. % up to 10 wt. %, the glass body comprising:
i. a macroscopic, production-related titanium profile, and
ii. a microscopic, production-related layer structure,

c. dividing the glass body into a plurality of rod-like glass body portions,

d. spatially measuring the titanium profile in each of the glass body portions,

e. connecting the glass body portions to form an elongate first glass component,

f. first homogenization treatment of the first glass component,

g. pushing together the first glass component to create a spherical glass system,

h. turning the glass system by more than 70 degrees,

i. stretching the glass system to form an elongate second glass component,

j. second homogenization treatment (2000) of the second glass component to create a substrate precursor, the substrate precursor being substantially free of layer structures,

characterized in that

the step of measuring comprises the steps of:

k. predetermining a desired spatial titanium distribution in the substrate precursor,

l. providing a model of a titanium apportionment in the substrate precursor, the model being dependent on
i. an arrangement of the plurality of glass body portions in the first glass component relative to one another,
ii. the spatial titanium profile in each of the glass body portions, and
iii. the effects of the step of pushing together and the step of turning on the spatial titanium profiles in the glass body portions,

m. calculating (1450) an optimal arrangement of the glass body portions relative to one another by means of the model so that a difference between titanium apportionment and titanium distribution is minimal,

n. positioning (1470) the glass body portions so that, in the step of connecting, the glass body portions are connected according to the calculated optimal arrangement.

|2.| The method according to embodiment 1, characterized in that the substrate precursor has a mass of more than 100 kg, in particular more than 200 kg, in particular more than 300 kg.

|3.| The method according to at least one of embodiments 1 or 2, characterized in that the method comprises the step of:

o. producing a second glass body having a titanium dioxide content of 3 wt. % up to 10 wt. %, the second glass body comprising:
i. a second, macroscopic, production-related titanium profile, and
ii. a second, microscopic, production-related layer structure,

p. dividing the second glass body into a plurality of rod-like glass body portions.

|4.| The method according to at least one of the preceding embodiments, characterized in that at least three, in particular at least five, in particular at least eight, glass body portions are connected to form the first glass component.

|5.| The method according to at least one of the preceding embodiments, characterized in that the difference between titanium apportionment and titanium distribution is less than 1.5% based on a maximum value of the titanium distribution, in particular less than 1.0%, in particular less than 0.5%.

|6.| The method according to at least one of the preceding embodiments, characterized in that the glass body comprises at least one of the following property profiles:

q. a macroscopic, production-related OH profile,

r. a macroscopic, production-related CTE profile,

s. a macroscopic, production-related fluorine profile,

t. a macroscopic, production-related bubble profile,

u. a macroscopic, production-related ODC profile,

v. a macroscopic, production-related Ti3+ profile,

w. a macroscopic, production-related profile of metallic impurities.

|7.| The method according to embodiment 6, characterized in that, in the step of measuring, at least one of the property profiles is measured in each of the glass body portions.

|8. | The method according to embodiment 7, characterized in that the step of measuring comprises the steps of:

x. predetermining a desired spatial property distribution in the substrate precursor,

y. providing a model of a property apportionment in the substrate precursor, the model being dependent on
i. an arrangement of the plurality of glass body portions in the first glass component relative to one another,
ii. a spatial property profile in each of the glass body portions, and
iii. the effects of the step of pushing together and the step of turning on the spatial property profile in the glass body portions,

z. calculating a best possible arrangement of the glass body portions relative to one another by means of the model so that a sum difference is minimal, the sum difference comprising
i. the difference between titanium apportionment and titanium distribution, and
ii. the second difference between the property apportionment and property distribution,

aa. positioning the glass body portions so that, in step of connecting, the glass body portions are connected according to the calculated best possible arrangement.

|9.| The method according to embodiment 8, characterized in that the sum difference is less than 1.5% based on a sum of a maximum value of the titanium distribution and a maximum value of the property distribution, in particular less than 1.0%, in particular less than 0.5%.

|10.| The method according to at least one of the preceding embodiments, characterized in that the step of producing the glass body comprises at least the steps of:

bb. creating a porous soot body, the macroscopic, production-related titanium profile substantially extending along a longitudinal axis, and the microscopic, process-related layer structure substantially extending along a growth axis,

cc. vitrifying the soot body to create the cylindrical glass body.

|11.| The method according to at least one of the preceding embodiments, characterized in that the first glass component is heated before the step of pushing together.

|12.| The method according to at least one of the preceding embodiments, characterized in that the connection takes place at a relevant contact surface of the glass body portions.

In the present description, range specifications also include the values specified as limits. A specification of the type “in the range of X to Y” with respect to a variable A consequently means that A can assume the values X, Y and values between X and Y. Ranges delimited on one side of the type “up to Y” for a variable A accordingly mean, as a value, Y and less than Y.

Some of the described features are linked to the term “substantially.” The term “substantially” is to be understood as meaning that, under real conditions and manufacturing techniques, a mathematically exact interpretation of terms such as “superimposition,” “perpendicular,” “diameter,” or “parallelism” can never be given exactly but only within certain manufacturing-related error tolerances. In particular, the term “substantially” may mean a variation of +/−5% of the relevant value. In particular, “substantially parallel axes” include an angle of −5 degrees to 5 degrees relative to one another, and “substantially equal volumes” include a deviation of up to 5 vol. %. An “apparatus consisting substantially of quartz glass” comprises, for example, a quartz glass content of ≥95 to ≤100 wt. %. Furthermore, “substantially at right angles” includes an angle of 85 degrees to 95 degrees.

### DETAILED DESCRIPTION

The invention relates to a method for producing a substrate precursor having a mass of more than 50 kg, comprising a TiO2-SiO2 mixed glass, comprising the steps of:

introducing a silicon dioxide raw material and a titanium dioxide raw material into a flame.

producing a glass body having a titanium dioxide content of 3 wt. % up to 10 wt. %, the glass body comprising:
i. a macroscopic, production-related titanium profile, and
ii. a microscopic, production-related layer structure,

dividing the glass body into a plurality of rod-like glass body portions,

spatially measuring the titanium profile in each of the glass body portions,

connecting the glass body portions to form an elongate first glass component,

first homogenization treatment of the first glass component,

pushing together the first glass component to create a spherical glass system,

turning the glass system by more than 70 degrees,

stretching the glass system to form an elongate second glass component,

second homogenization treatment of the second glass component to create a substrate precursor, the substrate precursor being substantially free of layer structures,

In order to overcome the aforementioned disadvantages in the prior art, it is provided according to the invention that the step of measuring comprises the steps of:

predetermining a desired spatial titanium distribution in the substrate precursor,

providing a model of a titanium apportionment in the substrate precursor, the model being dependent on
iii. an arrangement of the plurality of glass body portions in the first glass component relative to one another,
iv. the spatial titanium profile in each of the glass body portions, and
v. the effects of the step of pushing together and the step of turning on the spatial titanium profiles in the glass body portions,

calculating an optimal arrangement of the glass body portions relative to one another by means of the model so that a difference between titanium apportionment and titanium distribution is minimal,

positioning the glass body portions so that, in step of connecting, the glass body portions are connected according to the calculated optimal arrangement.

The scope of the described method relates to the optimization of a spatial distribution of titanium dioxide, in particular titanium dioxide and at least one other property, in a substrate precursor. For linguistic reasons, the terms “titanium” and “titanium dioxide” are used synonymously in the following. In fact, the invention and the specified do not relate to elemental titanium but to its oxidized form, titanium dioxide. Furthermore, the following words and endings are used to describe the spatial distributions of titanium dioxide and/or at least one other physical or chemical property in the different stages of the method:

in the glass body and in the glass body portion, the word “profile,”

in the substrate precursor, the word “frequency,”

in the model, the word “apportionment,” and

in the desired substrate precursor, the word “distribution.”

In this respect, by way of example, a titanium profile differs from a titanium frequency in that

the first denotes a titanium dioxide content at spatially different points within a glass body, and

the second denotes a titanium dioxide content at spatially different points within a substrate precursor.

The method enables the production of substrate precursors having a mass of more than 50 kg, in particular more than 100 kg, which fulfill the steadily growing demands on EUV mirror elements. In this case, the method comprises the steps of:

### Introducing

In the step of introducing, silicon dioxide raw material (for example, SiCl4 or OMCTS vapor) and a titanium dioxide raw material (for example, TiCl4 or Ti alkoxide vapor) are subjected to flame hydrolysis. In the process, SiO2 and TiO2 particles are formed.

### Producing

The SiO2 and TiO2 particles formed within the scope of flame hydrolysis can be deposited in two ways. In direct deposition (DQ process), deposition onto a stamp positioned below the flame takes place. As a rule, the temperature conditions are selected such that this deposition takes place, forming a compact TiO2-SiO2 mixed glass. In the axial vapor phase deposition process (VAD process), the deposition takes place in the form of a film of SiO2 and TiO2 particles on a carrier bar. Subsequently, in a second step, the particles are vitrified to form a TiO2-SiO2 mixed glass.

The result of this step is a glass body having a titanium dioxide content of 3 percent by weight (wt. %) up to 10 percent by weight (wt. %) TiO2, which comprises a microscopic, production-related layer structure, also referred to as a short-wave layer structure, which results from the layer-like deposition of the SiO2 and TiO2 particles.

The masses specified here and hereinafter always relate to the quantity of TiO2 (titanium dioxide), not to the elemental titanium.

Due to fluctuations in the mass flow controllers (MFC), mechanical inaccuracies of the burners or the holders of the burner and deposition systems, or stochastically and/or deterministically varying thermal boundary conditions during the construction, glass bodies which have dead weights of more than 50 kg, in particular more than 100 kg, in particular more than 200 kg, also comprise a macroscopic, production-related titanium profile in addition to the described microscopic, production-related layer structure. The short-wave layer structure has a size of less than 1 mm, in particular less than 0.5 mm.

This macroscopic titanium profile, also referred to as long-wave fluctuations or long-wave titanium profile, has specific fluctuation lengths of 0.15 m to 0.75 m, in particular 0.17 m to 0.5 m, in which the titanium dioxide content fluctuates by a maximum of 0.5 wt. %, in particular a maximum of 0.3 wt. %, in particular between 0.02 wt. % and 0.25 wt. %, in particular between 0.05 wt. % and 0.2 wt. %. In an exemplary glass body having a length of one meter and a titanium dioxide content of 10 wt. % and a macroscopic, production-related fluctuation of +/−0.5 wt. %, the titanium dioxide content can thus fluctuate spatially, in particular several times, between 10.5 wt. % and 9.5 wt. %.

### Dividing

The glass bodies created in the step of producing can have a cylindrical, rod-like or tubular shape. Along a predefined longitudinal axis, the glass body is divided into a plurality of rod-like glass body portions.

### Measuring

In the step of measuring, the titanium dioxide content is determined at a plurality of spatially different points. For example, an individual titanium profile is determined for each of the glass body portions created in the step of dividing. For this purpose, the content of titanium dioxide and/or of a property is measured along a longitudinal axis of the glass body portion. In this case, the measuring points are at a distance of less than 5 cm, in particular less than 2 cm, from one another. The measurement accuracy in the determination of the content of titanium dioxide is 0.005 wt. %.

### Connecting

A plurality of glass body portions are connected to one another in the step of connecting to form an elongate first glass component. In this case, the connection can in particular take place in an integrally bonded manner within the scope of a hot process. The term “hot process” is understood to mean a method step in which the temperature of an element is increased by heat input. Examples of hot processes:

Flame-based hot processes are based on the oxidation of an exothermically reacting gas. One example is the use of hydrogen, also referred to as “H2,” as fuel gas (flame hydrolysis). It reacts with the oxygen, also referred to as “O2,” in the air.

Flame-free hot processes use other heating systems that do not require an open flame. One example is the use of a resistor that converts electrical energy into thermal energy (heat).

First Homogenization Treatment

In a first homogenization treatment, the short-wave, microscopic layer structures of the first glass component are eliminated in one plane, in a crucible-free melting process. For this purpose, the first glass component can be clamped into the chucks of a glass lathe and softened in a zone-wise manner while the chucks rotate at different speeds or in a counterrotating manner about an axis of rotation. Due to the different rotation of the first glass component on either side of the softening zone, torsion (twisting) and thus mechanical intermixing occur there in the glass volume. The region of thermal-mechanical intermixing is also referred to as the “shear zone.” The shear zone has a length of 2 cm to 8 cm, which is more than one order of magnitude longer than the length of the short-wave layer structures which have lengths of less than 1 mm. The shear zone is displaced along a longitudinal axis of the first glass component and is intermixed over its length in the process. Microscopic, production-related layer structures are thus reduced or eliminated in one plane, in particular the plane of the shear zone.

If the TiO2-SiO2 mixed glass, which has passed through a homogenization treatment, is examined by means of a voltage detector and interferometer, it is found that the optical layer structure freedom in parallel with the plane of the shear zone used during homogenization is lower than the freedom of layer structure observed perpendicularly to the plane of the shear zone. This shows that the mixing effect that is used in the shear zone and serves to achieve the freedom of layer structure is smaller perpendicularly to the axis of rotation used during the homogenization treatment than the mixing effect observed along the axis of rotation.

### Pushing Together

After the first homogenization treatment, the first glass component is thermally heated and mechanically pushed together. By pushing together both ends along the longitudinal axis of the first glass component, a spherical glass system is created.

### Turning

Relative to the longitudinal axis of the first glass component, the spherical glass system is turned by more than 70 degrees. The angle of turning can in particular be between 70 and 110 degrees, in particular between 80 and 100 degrees.

### Stretching

After turning, the glass system is thermally heated to allow longitudinal stretching. This enables reshaping of the spherical glass system into an elongate, in particular rod-like, second glass component.

### Second Homogenization Treatment

In order to eliminate remaining microscopic, production-related layer structures, a second homogenization treatment of the second glass component takes place. The second homogenization treatment takes place analogously to the first homogenization treatment. For this purpose, the second glass component can be clamped in chucks of the glass lathe and softened in a zone-wise manner, while the chucks rotate at different speeds or in a counterrotating manner about an axis of rotation. Due to the different rotation of the second glass component on either side of the softening zone, torsion (twisting) and thus mechanical intermixing again occur in the glass volume. The shear zone is displaced along a second length of the second glass component and in the process, the latter is reshaped and intermixed over its length. Microscopic, production-related layer structures are thus reduced or eliminated in one plane, in particular the plane of the shear zone.

If the TiO2-SiO2 mixed glass, which has passed through both homogenization treatments, is examined by means of a voltage detector and interferometer, it is found that the microscopic, production-related layer structures have been substantially removed, in particular to at least 99% compared with the glass body.

As a result of the second homogenization treatment of the second glass component, a substrate precursor is created which is substantially free of microscopic, production-related layer structures.

In one embodiment, the first glass component and/or the second glass component is clamped, with the longitudinal axis oriented horizontally, in the rotation device, it being possible for holding elements for minimizing the losses of good material to be welded to the ends of the first glass component and/or the second glass component.

### Measuring According to the Invention:

In order to overcome the aforementioned disadvantages in the prior art, it is provided that the step of measuring comprises the steps of:

predetermining a desired spatial titanium distribution in the substrate precursor,

providing a model of a titanium apportionment in the substrate precursor, the model being dependent on
vi. an arrangement of the plurality of glass body portions in the first glass component relative to one another,
vii. the spatial titanium profile in each of the glass body portions, and
viii. the effects of the step of pushing together and the step of turning on the spatial titanium profiles in the glass body portions,

calculating an optimal arrangement of the glass body portions relative to one another by means of the model so that a difference between titanium apportionment and titanium distribution is minimal,

positioning the glass body portions so that, in the step of connecting, the glass body portions are connected according to the calculated optimal arrangement.

Within the scope of calculating the optimal arrangement, the positions of the glass body portions relative to one another are permuted. From each permutation, the model calculates a titanium apportionment, which is subsequently compared with the titanium distribution by difference formation. From the set of the difference, the optimal arrangement of the glass body portions relative to one another can then be determined, in which arrangement the difference, in particular the spatial difference, between titanium apportionment and titanium distribution is minimal.

### Predetermining

Within the scope of the step of predetermining, an optimal spatial distribution of titanium dioxide in the SiO2 matrix is determined. This titanium apportionment is the target value of the spatial distribution of the titanium in the substrate precursor and should optimally be achieved during production.

The titanium apportionment includes both the absolute quantity of titanium dioxide in the substrate precursor and its spatial distribution. By way of example, the substrate precursor may have a cuboid shape. In this case, the titanium apportionment can be configured parabolically, the maximum of the titanium apportionment being arranged in a center of a surface of the substrate precursor. In addition, different edge regions of the substrate precursor can have the same or different titanium apportionments. In a further embodiment, the titanium apportionment can be configured flat, i.e., homogeneously, over the entire substrate precursor.

### Providing

The method according to the invention comprises the use of a model of a titanium apportionment in the substrate precursor. This model calculates a spatial distribution of titanium dioxide in the SiO2 matrix. In this case, the following are used as input parameters of the model:

A/ an arrangement of the plurality of glass body portions relative to one another in the first glass component,

B/ the individual, spatial titanium profile in a plurality of glass body portions, and

C/ the effects of the step of pushing together and the step of turning on the spatial titanium profiles in the glass body portions.

In the calculation of the spatial distribution of titanium dioxide in the SiO2 matrix on the basis of the mentioned input parameters, the model can take into account further aspects.

In the production of a glass body, long-wave and short-wave fluctuations in the quantity of titanium and/or other properties in the SiO2 matrix occur. The two types are influenced differently in the method steps of the method disclosed herein. By means of the model, in the step of connecting, the titanium distribution for a multiplicity of arrangements of the glass body portions can be calculated and compared with a target value. The required quality of large substrate precursors can thus be achieved and waste can be reduced.

The starting point is that both the first and the second homogenization treatment act only on the short-wave (microscopic) layer structures and/or short-wave (microscopic) changes in the content of titanium dioxide. In contrast, long-wave changes in the content of titanium dioxide remain uninfluenced by the two homogenization treatments. This fact results from the different length scales of the shear zone and of the macroscopic, production-related titanium profile. The shear zone has an elongate extension which is only a few centimeters. Within this shear zone, only short-wave structures located in the plane of the shear zone are compensated.

The long-wave variations in the content of titanium dioxide are not influenced by the two homogenization treatments. This is because the fluctuation lengths of the long-wave variations in the content of titanium dioxide and/or a property are at least twice as long as the width of the shear zone.

The step of turning does not influence the short-wave (microscopic) layer structures and/or short-wave (microscopic) changes in the content of titanium dioxide. However, the step of turning ensures that the shear zones of the first and second homogenization treatments are arranged substantially perpendicularly to one another with respect to the longitudinal axis of the first glass component. As a result, short-wave fluctuations are to be leveled as completely as possible.

The step of turning influences the long-wave fluctuations. By pushing together the first glass component in the step of pushing together, different long-wave fluctuations from different glass body portions are mixed with one another. Removed volume elements of the first glass component are brought into direct proximity by the process and can be combined in the following step. As a result, it is possible in particular, depending on the titanium profile and/or property profile, to arrive at an amplification or attenuation of the fluctuation level of the long-wave fluctuations. The amplification or attenuation of the fluctuation level consequently depends on the profiles of the titanium and/or of the properties and on the arrangement of the individual glass body portions relative to one another.

Finally, the glass body portions are again located in different planes of the substrate precursor. The number of planes depends on the mass of the substrate precursor and the number and the mass of the glass body portions. In one variant,
for a substrate precursor having a mass of more than 50 kg, the number of planes can be between 2 and 5,
for a substrate precursor having a mass of more than 100 kg, the number of planes can be between 3 and 10,
for a substrate precursor having a mass of more than 200 kg, the number of planes can be between 5 and 20,

for a substrate precursor having a mass of more than 300 kg, the number of planes can be between 10 and 30.

An exception to the statement that the step of turning influences the long-wave fluctuations applies to a macroscopic quartz glass volume element that is arranged in a center of the elongate first glass component and in particular is of a size of between 20 cm3 and 100 cm3. Long-wave variations in the properties, such as in the quantity of titanium in the SiO2 matrix, are also found again in this macroscopic volume element. The step of turning changes the position of this volume element only in such a way that it is again located in the center of the spherical glass system. During subsequent stretching, this volume element is again arranged in the center of the elongate second glass component. Consequently, said volume element, having its long-wave fluctuations which are uninfluenced by the homogenization, is again arranged centrally in the second glass component.

In a further embodiment, the step of second homogenization treatment is followed by the step of flowing out into a graphite mold. After the step of flowing out, the described quartz glass element is located in the center of the substrate precursor and thus substantially determines its behavior. This applies all the more as a convex recess is frequently ground into the substrate precursor, which recess receives the actual mirror, and the volume element located directly below the recess thus greatly influences the behavior of the mirror during use.

Consequently, the model can take into account at least one of the following aspects in order to search for an optimum in which the following aspects are minimal and/or optimal:

D/ the content of titanium dioxide in functional regions, in particular in a central volume element of the substrate precursor, and

E/ the content of titanium dioxide in different planes of the substrate precursor.

The model, which is dependent at least on the three listed input parameters A/ to C/, calculates the spatial distribution of titanium dioxide in the SiO2 matrix of the substrate precursor that may potentially result during passage through the method steps, which results
in different arrangements of the plurality of glass body portions relative to one another in the first glass component, and/or
in a selection of the plurality of glass body portions from a larger multiplicity of glass body portions, combined with different arrangements of the plurality of glass body portions relative to one another in the first glass component.

### Calculating

The possibilities for titanium apportionments in the substrate precursor calculated, using the model, by permutation of the arrangement of the glass body portions relative to one another are compared with the desired titanium apportionment in the substrate precursor. Since the titanium distribution represents the desired target value, the arrangements of the plurality of glass body portions in which a difference between titanium apportionment and titanium distribution is minimal are selected.

As explained, the titanium profile is determined at points in the step of spatial measurement. In one variant, the model determines only a set of points, and not a complete curve of the titanium distribution. According to the invention, a difference is in each case calculated for each of the possible permutations of the arrangement of the glass body portions.

In one embodiment, the difference of the number series is determined by means of the root mean square (RMS). Subsequently, the model checks which of all the possible permutations of the arrangement of the glass body portions leads to a minimum difference, i.e., a difference smallest in magnitude. The arrangement of the glass body portions of which the calculated difference between titanium apportionment and titanium distribution is minimal is then used in the step of connecting.

In one embodiment, the difference of the number series is determined by means of the sum of the magnitude of the differences.

In one embodiment, the difference of the number series is determined by means of the arithmetic mean.

In one embodiment, a minimum difference is understood to mean that the difference between the magnitude of the titanium apportionment and the magnitude of the titanium distribution is less than 1.5% of a maximum value of the titanium distribution, in particular less than 1.0%, in particular less than 0.5%. The specified magnitudes of the difference are consequently relative values, based on the maximum value of the titanium distribution.

In one embodiment, in order to determine the difference, at least 75%, in particular over at least 85%, in particular at least 90%, of a surface of the substrate precursor is taken into account.

In one embodiment, in order to determine the difference, at least 75%, in particular over at least 85%, in particular at least 90%, of a surface of the substrate precursor, which is mirrored in a further step to form a mirror element, is taken into account.

### Positioning

The desired substrate precursor is subsequently achieved by connecting the glass body portions, in the step of connecting, according to the calculated optimal arrangement.

One embodiment is characterized in that the substrate precursor has a mass of more than 200 kg, in particular more than 300 kg. Within the scope of OVD or DQ methods, the macroscopic, production-related titanium profile can be a spatial variation of the titanium dioxide content of up to 0.5% based on the desired titanium dioxide content within a 200 kg TiO2-SiO2 mixed glass. The spatial variation of the titanium dioxide content generally has a continuous profile, the fluctuation lengths being between 10 cm and 50 cm. In contrast, the shear zone and second shear zone, in which the TiO2-SiO2 mixed glass is mixed within the scope of the two homogenization treatments, have a length of 2 cm to 8 cm.

In the case of substrate precursors having a mass of more than 100 kg, in particular more than 200 kg, in particular more than 300 kg, the first glass component has a length of more than 2 m, in particular more than 2.8 m. Consequently, a plurality of macroscopic, production-related fluctuations in the titanium profile can occur, which would have no effects in the case of smaller substrate precursors having a mass of less than 30 kg. One embodiment is characterized in that the method has the following step after the second homogenization treatment:
reshaping the second glass component by softening and flowing out into a heated mold into which the second glass component flows out under the action of a force, forming the substrate precursor.

In one embodiment, the step of flowing out can serve in particular to convert rod-like TiO2-SiO2 mixed glass in the second glass component into a block-like substrate precursor. For this purpose, the mold can have a block-like interior, into which the TiO2-SiO2 mixed glass of the second glass component flows out. In particular, the mold can have an interior which corresponds to the desired contour and geometry of the desired mirror, and the substrate precursor does not require any significant reworking (referred to as “near net shape”).

Within the scope of the step of flowing out, the second glass component can be placed in the heated mold and can flow out there under the dead weight or under an additional force acting in the axial direction. Instead of the slow flowing-out in the heated mold, the same deformation can also be achieved in that the second glass component is continuously fed to a heating zone and, there, the mold arranged in the heating region is softened over its length.

One embodiment is characterized in that the method comprises the step of:

dd. producing a second glass body having a titanium dioxide content of 3 wt. % up to 10 wt. %, the second glass body comprising:
i. a second, macroscopic, production-related titanium profile, and
ii. a second, microscopic, production-related layer structure,

ee. dividing the glass body into a plurality of rod-like glass body portions.

In order to produce substrate precursors having a mass of more than 100 kg, in particular more than 200 kg, in particular more than 300 kg, it may be necessary to produce not only a first glass body but also a second glass body.

In this case, the first and the second glass bodies have different macroscopic, production-related titanium profiles. After the step of producing, the glass body is divided into a plurality of rod-like glass body portions, and the second glass body is divided into a plurality of rod-like glass body portions.

In one embodiment, all of the plurality of rod-like glass body portions resulting from the first glass body and all of the plurality of rod-like glass body portions resulting from the second glass body are joined together to form the first glass component.

In one embodiment, the multiplicity of glass body portions resulting from the sum of
the plurality of rod-like glass body portions resulting from the first glass body and
the plurality of rod-like glass body portions resulting from the second glass body

is larger than the required plurality of rod-like glass body portions for creating the first glass component. In this case, a selection from the multiplicity of available glass body portions for the required plurality is made within the scope of the step of calculating so that a difference between titanium apportionment and titanium distribution is minimal.

In one embodiment,
the multiplicity of glass body portions is a multiple of the plurality by a factor of 1.1 to 2, in particular
the multiplicity of glass body portions is at least twenty, and the plurality of glass body portions joined together to form the first glass component is at most fifteen, in particular
the multiplicity of glass body portions is at least fifteen, and the plurality of glass body portions joined together to form the first glass component is at most ten.

By means of the disclosed method, a selection can be made which overcomes the aforementioned disadvantages in the prior art.

One embodiment is characterized in that at least three, in particular at least five, in particular at least eight, glass body portions are connected to form the first glass component.

In the case of substrate precursors having a mass of more than 100 kg, a plurality of glass body portions which are connected to one another is required. On account of fluctuation lengths between 10 cm and 50 cm of the spatial variations of the titanium dioxide content, the method according to the invention is particularly suitable in the case of a combination of more than three, in particular more than five, in particular more than eight, glass body portions, in order to create a substrate precursor that meets the strict requirements of EUV microlithography.

One embodiment is characterized in that the difference between titanium apportionment and titanium distribution is less than 1.5% based on a maximum value of the titanium distribution, in particular less than 1.0%, in particular less than 0.5%.

Within the scope of the step of measuring, a minimum of the difference between titanium apportionment and titanium distribution is determined by means of the comparison between the model and the desired titanium distribution. Due to the ever-increasing demands on the material properties of the substrate precursors, the absolute value of the difference can be subject to the aforementioned limits.

One embodiment is characterized in that the glass body comprises at least one of the following property profiles:
a macroscopic, production-related OH profile,
a macroscopic, production-related CTE profile,
a macroscopic, production-related fluorine profile,
a macroscopic, production-related bubble profile,
a macroscopic, production-related ODC profile,
a macroscopic, production-related Ti3+ profile,
a macroscopic, production-related profile of metallic impurities.

In the case of OVD or DQ methods, macroscopic, production-related variations of the properties listed above can occur. The fluctuation lengths occurring in this case are comparable to those of titanium dioxide and are in particular between 12.5 cm and 50 cm in the case of OH, CTE, Ti3+ and between 15 cm and 85 cm in the case of fluorine, bubbles, ODC, metallic impurities.

One embodiment is characterized in that, in the step of measuring, at least one of the property profiles is measured in each of the glass body portions.

One embodiment is characterized in that the step of measuring comprises the steps of:
ff. predetermining a desired spatial property distribution in the substrate precursor,
gg. providing a model of a property apportionment in the substrate precursor, the model being dependent on

i. an arrangement of the plurality of glass body portions in the first glass component relative to one another,

ii. a spatial property profile in each of the glass body portions, and

iii. the effects of the step of pushing together and the step of turning on the spatial property profile in the glass body portions,
hh. calculating a best possible arrangement of the glass body portions relative to one another by means of the model so that a sum difference is minimal, the sum difference comprising
i. the difference between titanium apportionment and titanium distribution, and
ii. the difference between property apportionment and property distribution,

ii. positioning the glass body portions so that, in the step of connecting, the glass body portions are connected according to the calculated best possible arrangement.

In parallel with the step of predetermining the titanium distribution, in this variant, at least one desired spatial property distribution in the substrate precursor is predetermined. In addition to the titanium distribution, the at least one property distribution thus represents a second target value which is optimally fulfilled and/or sought in the substrate precursor.

In one variant, the sum difference can be calculated from the sum

i. of the magnitude of the difference between titanium apportionment and titanium distribution, and

ii. of the magnitude of the difference between property apportionment and property distribution.

Just like the titanium profile, the property profile is also measured at points. The model then in each case calculates the values of the property in the substrate precursor (the property apportionment) from the set of values for the property. The model can thus calculate, from the set of values, a difference between property apportionment and property distribution, for each of the possible permutations of the arrangement of the glass body portions.

Based thereon, the model can determine, for each of the possible permutations of the

arrangement of the glass body portions, two independent differences, namely

iii. the difference between titanium apportionment and titanium distribution, and

iv. the difference between property apportionment and property distribution.

In one embodiment, each of the two differences is determined by means of the root mean square (RMS). In one embodiment, each of the two differences is determined by the arithmetic mean.

Subsequently, the model forms a sum difference for each possible permutation. In this case, the two differences to be considered can be added to one another in different ways.

The sum difference can thus be calculated from

v. the sum of the magnitudes of the two differences to be considered, or

vi. the arithmetic mean or geometric means of the two differences to be considered, or

vii. the weighted average of the two differences to be considered.

In one variant, in the determination of the sum difference, the model can weight

viii. the difference between titanium apportionment and titanium distribution, and

ix. the difference between property apportionment and property distribution

differently. For example, the difference between titanium apportionment and titanium distribution can be taken into account twice or three times in the search for the minimum of the sum difference, since the quantity of titanium dioxide substantially influences the CTE and thus has to be taken into particular consideration for the intended use.

In one embodiment, a minimum sum difference is understood to mean that
the difference between the titanium apportionment and the titanium distribution over at least 75%, in particular over at least 85%, in particular at least 90%, of a surface of the substrate precursor is less than 1.5% based on a maximum value of the titanium distribution, in particular less than 1.0%, in particular less than 0.5%, and

the difference between the property apportionment and property distribution over at least 75%, in particular over at least 85%, in particular at least 90%, of a surface of the substrate precursor is less than 1.5% based on a maximum value of the property distribution, in particular less than 1.0%, in particular less than 0.5%.

In one embodiment, a minimum sum difference is understood to mean that

the difference between the titanium apportionment and the titanium distribution over at least 75%, in particular over at least 85%, in particular at least 90% of a surface, which is mirrored in a further step to form a mirror element, of the substrate precursor is less than 1.5% of a maximum value of the titanium distribution, in particular is less than 1.0%, in particular less than 0.5%, and

the difference between the property apportionment and property distribution over at least 75%, in particular over at least 85%, in particular at least 90%, of a surface of the substrate precursor, which is mirrored in a further step to form a mirror element, is less than 1.5% of a maximum value of the property distribution, in particular less than 1.0%, in particular less than 0.5%.

The model used in this variant is functionally dependent on

jj. an arrangement of the plurality of glass body portions in the first glass component relative to one another,

kk. the spatial titanium profile and a spatial property profile in each of the glass body portions, and

ll. the effects of the step of pushing together and the step of turning on the spatial titanium profile and on the spatial property profile in the glass body portions.

Consequently, both the aspects relating to titanium dioxide and the aspects relating to the

at least one further property (e.g., ODC, Ti3+, etc.) are taken into account in the calculation of the optimal arrangement of the glass body portions.

Based on the solution space of possible arrangements of the glass body portions relative to one another, a best possible arrangement of the glass body portions is determined by permutation.

In this case, the aim is for the sum difference to be minimal, the sum difference comprising

i. the difference between titanium apportionment and titanium distribution, and

ii. the second difference between the at least one property apportionment and the at least one property distribution.

Subsequently, a positioning of the glass body portions takes place such that, in the step of connecting, the glass body portions are connected according to the calculated best possible arrangement.

One embodiment is characterized in that the sum difference is less than 1.5% of the sum of a maximum value of the titanium distribution and a maximum value of the property distribution, in particular less than 1.0%, in particular less than 0.5%.

One embodiment is characterized in that
the difference between titanium apportionment and titanium distribution is less than 1.5%, in particular less than 1.0%, in particular less than 0.5%, of the maximum value of the titanium distribution, and
the second difference between the at least one property apportionment and the at least one property distribution is less than 1.5%, in particular less than 1.0%, in particular less than 0.5%, of the maximum value of the relevant property distribution.

This embodiment is particularly suitable for fulfilling the high demands on EUV substrate precursors. Substrate precursors that have differences and second differences that are above the listed values are often not usable for the creation of mirror substrates that have deviations from predicted line edges of less than 3 nm.

One embodiment is characterized in that
the difference between titanium apportionment and titanium distribution is between 0.15% and 1% of the maximum value of the titanium distribution, and the second difference

iii. between the Ti3+ apportionment and the Ti3+ distribution is less than 5.0%, in particular less than 2.0%, of the maximum value of the Ti3+ distribution, and

iv. between the OH apportionment and the OH distribution is less than 2.0%, in particular less than 1.0%, in particular less than 0.5%, of the maximum value of the OH distribution.

This embodiment is particularly suitable for creating substrate precursors from which mirror substrates can be created that have deviations from predicted line edges of less than 3 nm.

One embodiment is characterized in that the step of producing the glass body comprises at least the steps of:

mm. creating a porous soot body, the macroscopic, production-related titanium profile extending along a longitudinal axis, and the microscopic, process-related layer structure extending along a growth axis,

nn. vitrifying the soot body to create the cylindrical glass body.

In one embodiment of the invention, the step of creating a porous soot body comprises the method steps of:

oo. providing a liquid SiO2 feedstock comprising more than 60 wt. % the polyalkylsiloxane D4,

pp. evaporating the liquid SiO2 feedstock into a gaseous SiO2 feedstock vapor,

qq. evaporating a liquid TiO2 feedstock into a gaseous TiO2 feedstock vapor,

rr. converting the SiO2 feedstock vapor and the TiO2 feedstock vapor to SiO2 particles and TiO2 particles,

ss. depositing the SiO2 particles and the TiO2 particles on a deposition surface, forming the porous soot body.

Octamethylcyclotetrasiloxane (also referred to here as D4) forms the main component during the production of the soot body. The production of a soot body according to the aforementioned steps reduces the thicknesses of the macroscopic, production-related titanium dioxide profiles and/or property profiles.

One embodiment is characterized in that the first glass component is heated before the step of pushing together. By heating, the first glass component becomes at least partially viscous, which facilitates mechanical deformation. The heating can take place within the scope of a flame-based hot process or a flame-free hot process.

One embodiment is characterized in that the connection takes place on a relevant contact surface of the glass body portions.

The features disclosed in the description may be essential for different embodiments of the claimed invention, both separately and in any combination with one another.

The values specified for the difference, the sum difference and the second difference are relative values which relate to the relevant distribution, i.e., the relevant quantity sought in the substrate precursor.

In this document, embodiments that disclose two or more features, which each have preferred ranges or alternatives, are to be understood to include all possible combinations of these features.

In the present description, range specifications also include the values specified as limits. A specification of the type “in the range of X to Y” with respect to a variable A consequently means that A can assume the values X, Y and values between X and Y. Ranges delimited on one side of the type “up to Y” for a variable A accordingly mean, as a value, Y and less than Y.

In the following, the invention is illustrated further, by way of example, by figures. The invention is not limited to the figures.

### FIGURES

Shown are:

FIG. 1 creation of a soot body,

FIG. 2 vitrification of the soot body into a glass body,

FIG. 3 the glass body,

FIG. 4 a glass body portion which was created from a division of the glass body,

FIG. 5 a representation of a two-dimensional, macroscopic, production-related titanium profile in a glass body portion,

FIG. 6 an arrangement of two glass body portions,

FIG. 7a a substrate precursor,

FIG. 7b a representation of a titanium profile of a plurality of glass body portions compared to a desired titanium distribution,

FIG. 8 a further illustration of a titanium profile of a plurality of glass body portions compared to a desired titanium distribution,

FIG. 9 a first homogenization treatment,

FIG. 10 a pushing together of the first glass component,

FIG. 11 a second homogenization treatment, and

FIG. 12 a representation of the method according to the invention.

### DESCRIPTION OF THE FIGURES

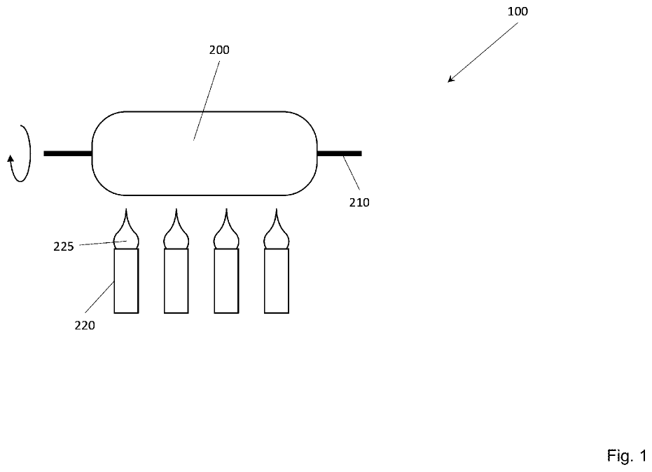

FIG. 1 shows an apparatus 100 for producing a titanium-doped SiO2 soot body 200. A multiplicity of flame hydrolysis burners 220 arranged in a row is arranged along a carrier tube 210 made of aluminum oxide.

A silicon dioxide raw material and a titanium dioxide raw material are fed to the reaction zone of the flame hydrolysis burner 220 in gaseous form and are decomposed in the process by oxidation and/or hydrolysis and/or pyrolysis. In the reaction zone, both SiO2 particles and TiO2 particles are formed, both of which are deposited In layers on the carrier tube 210, forming the SiO2-TiO2 soot body 200. The SiO2-TiO2 particles themselves are present in the form of agglomerates or aggregates of SiO2 primary particles having particle sizes in the nanometer range.

In particular due to the layered construction, the soot body 200 can comprise a microscopic layer structure.

In particular in the production 1100 of large-volume cylindrical soot bodies 200, for producing a substrate precursor 900 having a mass of more than 50 kg, in particular more than 100 kg, in particular more than 200 kg, the flame hydrolysis burners 220 can be mounted on a common burner block which is moved back and forth, in parallel with a longitudinal axis of the carrier tube 210, between two turning points which are stationary with respect to the longitudinal axis.

This movement of the flame hydrolysis burners 220, mechanical inaccuracies in the feed lines of the raw materials or the burners 220, or also variations in the process temperatures can lead to the soot body 200 having a macroscopic, production-related spatial fluctuation in the physical properties, such as the TiO2 content.

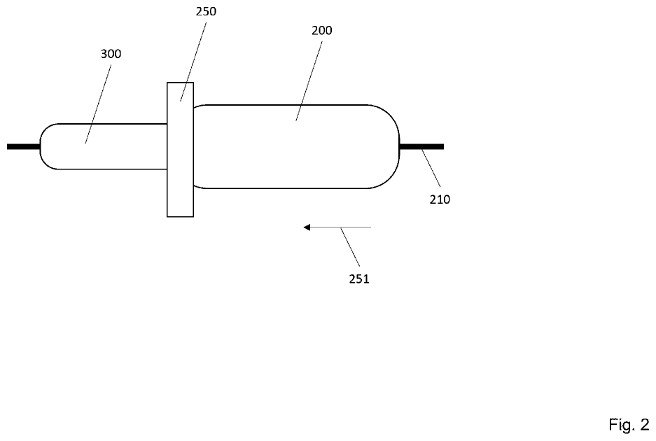

FIG. 2 shows a vitrification of the soot body 200. The vitrification preferably takes place in a process chamber. Preferably, the vitrification temperature is in a range from 1200 to 1500° C., preferably 1250 to 1350° C. In order to avoid bubble formation in the later quartz glass, it has proven advantageous if, during the vitrification, the pressure within the process chamber is lower than outside the process chamber, i.e., the vitrification is carried out at reduced pressure. This furthermore has the advantage that the material of the process chamber is not affected by aggressive and corrosive gases and is therefore subject to reduced wear. Therefore, an embodiment is preferred in which the vitrification preferably takes place at a pressure of less than 1 mbar. Within the scope of the vitrification, the soot body 200 can be moved through a vitrification furnace 250 according to movement arrow 251.

As a result of the vitrification, a glass body 300 having a titanium dioxide content of 3 wt. % up to 10 wt. % results from the soot body 200. The production-related fluctuations in the physical properties which have already occurred in the soot body 200 are transferred to the glass body 300, so that the latter has

tt. a macroscopic, production-related titanium profile, and

uu. a microscopic, production-related layer structure.

The mass specified for titanium of 3 wt. % up to 10 wt. % relates to the quantity of TiO2 (titanium dioxide), not of elemental titanium.

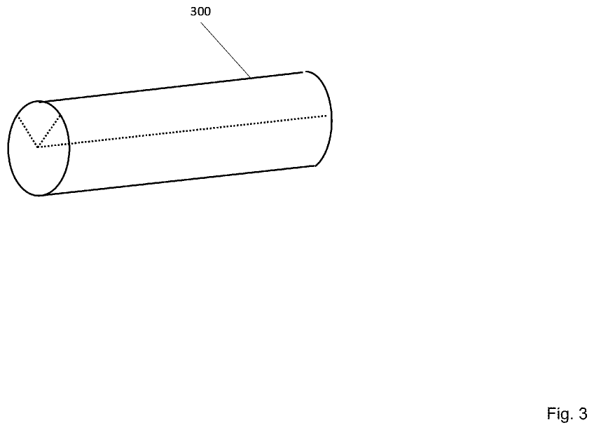

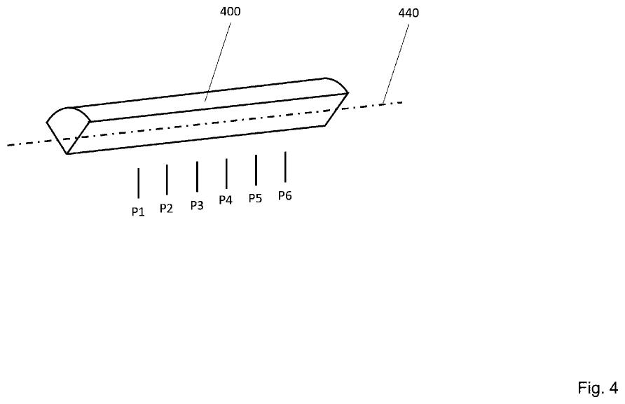

FIG. 3 shows the cylindrical glass body 300. A dotted line indicates a portion which, within the scope of the step of dividing 1200, is cut out of the glass body. The rod-like glass body portion 400 thus created is shown in FIG. 4. In particular, the glass body 300 can be divided into a plurality of rod-like glass body portions 400 which have a longitudinal axis 440. In particular, the glass body portions 400 can have a circular sector-like cross section.

By means of a first homogenization treatment 1600 of a first glass component and a second homogenization treatment 2000 of a second glass component, the microscopic, production-related layer structure is reduced so greatly that the glass body portion 400 is substantially free of layer structures. However, the two homogenization treatments 1600, 2000 do not allow the substrate precursor 900 to be free of long-wave titanium profiles, which substantially influence the quality and usability of the substrate precursor 900 in EUV lithography.

FIG. 4 shows the glass body portion 400 on which a titanium profile 410 is measured spatially. For this purpose, the content of titanium dioxide is measured at a plurality of measuring points (P1, P2, P3, P4, P5, P6) along the longitudinal axis 420. These measuring points are at a distance of less than 5 cm, in particular less than 2 cm, from one another. This pointwise measurement of the content of titanium dioxide reflects a clear image of the ratios in the glass body portion 400. Any fluctuations in the titanium profile occur on length scales of 0.15 m to 0.75 m.

In addition, further macroscopic, production-related variations of chemical and/or physical properties of the glass body 300 can occur within the scope of the production 1100 of the soot body 200, due to mechanical influences. At least one of these variations denoted as a property profile 510 can likewise be determined in the step of measuring 1300. The following chemical and/or physical properties, which have macroscopic, production-related property profiles 510, can be measured individually or in any combination: OH content, CTE, fluorine content, bubble content, ODC content, Ti3+ content, and content of metallic impurities.

The property profile 510 can be measured in parallel with and analogously to the titanium profile 410. For this purpose, the physical property is measured at a plurality of measuring points (P1, P2, P3, P4, P5, P6) along the longitudinal axis 420. Here too, the measuring points are at a distance of less than 5 cm, in particular less than 2 cm, from one another.

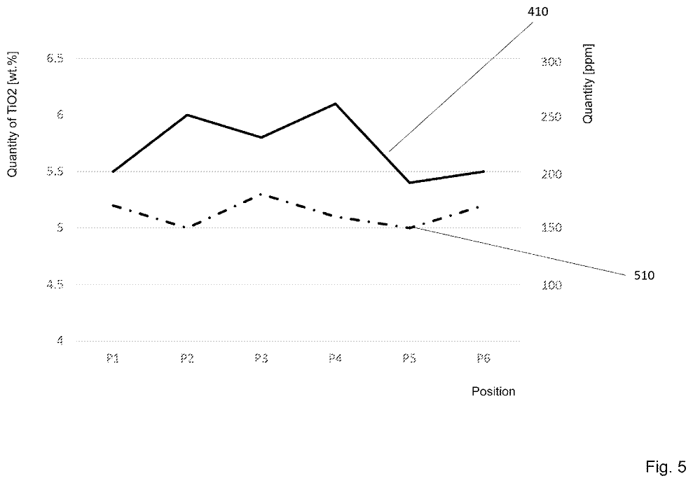

FIG. 5 schematically shows the result of a measurement 1300 of a titanium profile 410 and of a property profile 510 in the glass body portion 400. The quantity in wt. % of titanium dioxide or in ppm of the property is plotted as a function of the position along the longitudinal axis 440 of the glass body portion 400. In order to simplify the description, only measurement results for six measuring points (P1, P2, P3, P4, P5, P6) are shown in FIGS. 4 and 5.

The steps and/or aspects of the spatial measuring 1300 of the titanium profile 410 described below also apply to a spatial measurement of at least one property profile 510.

As can be seen from the graph, the content of titanium dioxide is within the predefined interval of 3 wt. % to 10 wt. %. However, for production-related reasons, this content of titanium dioxide fluctuates between 5.4 wt. % to 6.1 wt. % along the longitudinal axis 420 of the glass body portion 400.

The quantity of a property, here by way of example the OH content in ppm, measured at the six measuring points (P1, P2, P3, P4) is also shown, as the property profile 510. For production-related reasons, this content of OH fluctuates, along the longitudinal axis 420 of the glass body portion 400, between 150 ppm to 175 ppm.

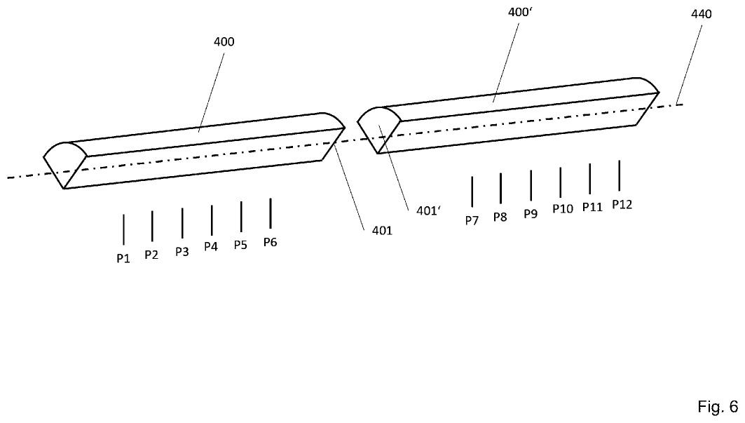

FIG. 6 shows a connection 1500 of a plurality of, in this case two, rod-like glass body portions 400, 400′ for forming an elongate first glass component 600.

For this purpose, a planar contact surface 401 of the first glass body portion 400 and a planar contact surface 401′ of the second glass body portion 400′ can be joined together by wringing and welded to one another. This is a “cold connection method” in which at most the immediate region of the contact surface experiences notable heating.

Alternatively, the connecting 1500 may comprise a connection step in which both glass

body portions 400, 400′ are softened and joined together in a furnace. This is a “hot connection method” in which the individual glass body portions 400, 400′ are joined together by welding. As described, the titanium dioxide profiles and/or property profiles are measured at a plurality of measuring points. For the glass body portion 400, the titanium profile 410 is measured, by way of example, at the measuring points P1, P2, P3, P4, P5, P6. For the glass body portion 400′, the titanium profile 410′ is measured, by way of example, at the measuring points P7, P8, P9, P10, P11, P12.

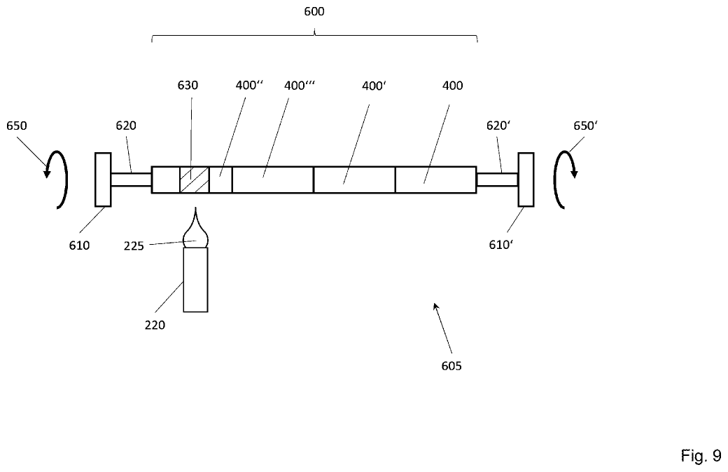

Within the scope of the method, at least three, in particular at least five, in particular at least eight, glass body portions can thus be connected to one another to form a first glass component 600, which is also illustrated in FIG. 9.

As illustrated in FIG. 5, the titanium profile 410 fluctuates along the longitudinal axis of the glass body portion 400. In addition, however, the titanium profile also fluctuates between different glass body portions 400, 400′. In the prior art, these macroscopic, production-related fluctuations in the individual titanium profiles between different glass body portions 400, 400′ were not taken into account further. Rather, only a few, in particular only two, glass body portions 400, 400′ were hitherto required for substrate precursors 900 having a low mass, so that the fluctuations occurring between the long-wave titanium profiles 410 in the glass body portions 400, 400′ could be ignored. This is no longer possible in the production of substrate precursors having a mass of more than 50 kg, in particular more than 100 kg, in particular if at least four glass body portions have to be connected to one another.

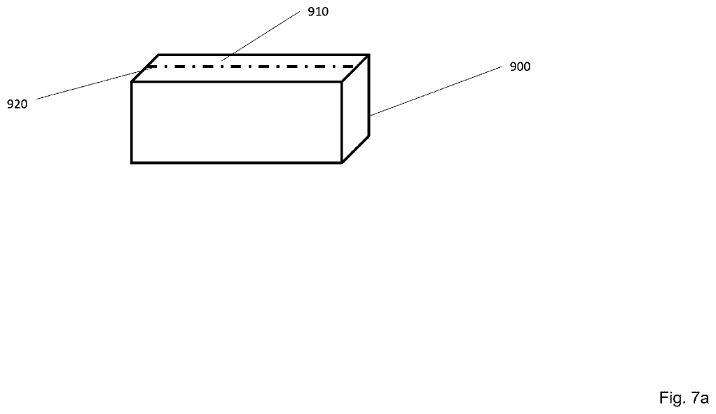

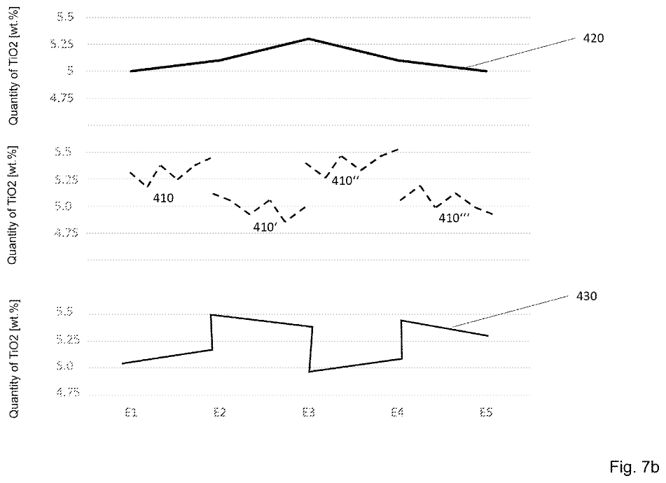

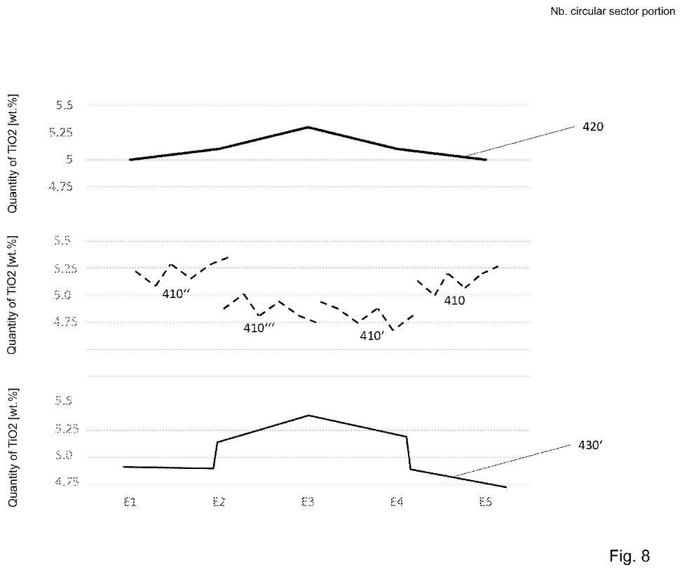

FIGS. 7a, 7b and FIG. 8 illustrate the steps used within the scope of the step of measuring 1300, which steps serve to overcome the aforementioned disadvantages.

It is to be set out how, by permutation of the arrangement of the glass body portions 400, 400′, 400″, 400′″ relative to one another, with the aid of the model, a titanium apportionment 430 is in each case calculated and compared with the desired titanium distribution 420.

The steps and/or aspects, described below, of minimizing a difference between titanium apportionment and titanium distribution also apply to the minimization of a second difference between at least one property apportionment and at least one property distribution.

The starting point is predetermining 1400 a desired titanium distribution 420 in the

substrate precursor. In one variant, the titanium distribution 420 represents the two-dimensional distribution of the quantity of the TiO2 in the substrate precursor, in particular along a center line, in particular at the outer surface to be mirrored later, through the substrate precursor. In this embodiment, the model can calculate a two-dimensional titanium distribution in the substrate precursor from the two-dimensionally determined titanium profiles and their arrangement relative to one another.

FIG. 7a shows a substrate precursor 900. Optimally, the latter should have a titanium distribution 420 as shown in the top graph in FIG. 7b. By way of example, a parabolic titanium distribution 420 having a maximum in a center of the substrate precursor is sought within an interval of 4.75 wt. % to 5.5 wt. % TiO2.

The desired two-dimensional titanium distribution 420 can be found in the substrate precursor 900 along a center line 920 on the outer surface 910 to be mirrored later. The type and design of the titanium distribution 420 can in particular be dependent on the type of use and the conditions of use of the later EUV mirror. A titanium distribution having a parabolic (or Gaussian) profile having a maximum in the center of the substrate precursor is particularly preferred. In particular, the titanium distribution, and thus the CTE, can be adapted to the distribution of the incident EUV radiation.

In order to illustrate the procedure, it is assumed in FIG. 7b that the substrate precursor 900 is formed from only four glass body portions 400, 400′, 400″, 400′″. In a manner analogous to FIG. 6, they are arranged relative to one another such that a rod-like glass body 300 is formed. In this case, the four glass body portions 400, 400′, 400″, 400′″ were joined together in the following arrangement to form the first glass component 600:

end side of the glass body portion 400 is connected to the front face of the glass body portion 400′ (point E2),

end side of the glass body portion 400′ is connected to the front face of the glass body portion 400″ (point E3),

end side of the glass body portion 400″ is connected to the front face of the glass body portion 400′″ (point E4).

The center graph in FIG. 7b shows the titanium profiles 410, 410′, 410″, 410′″ of the four glass body portions 400, 400′, 400″, 400′″, which were created from at least one glass body 300.

The set of measured values for the quantities of TiO2 in wt. % in each of the four glass body portions 400, 400′, 400″, 400′″ is plotted.

In order to overcome the aforementioned disadvantages, a model is used which can calculate a titanium apportionment 430 in the substrate precursor 900. In this case the model uses, as input parameters:

the arrangement of the plurality of glass body portions 400, 400′, 400″, 400′″ relative to one another in the first glass component 600,

the spatial titanium profiles 410, 410′, 410″, 410′″ in each of the glass body portions 400, 400′, 400″, 400′″, and

the effects of the step of pushing together 1700 and the step of turning 1800 on the spatial titanium profiles 410, 410′, 410″, 410′″ in the glass body portions 400, 400′, 400″, 400′″.

Based on this arrangement, the model calculates the titanium apportionment 430 in the substrate precursor 900. This titanium apportionment 430 is shown in the bottom graph in FIG. 7b.

As illustrated in FIG. 7b, the illustrated profile of the calculated titanium apportionment 430 does not correspond simply to a linear sequence of the illustrated profiles of the titanium profiles 410, 410′, 410″, 410′″ in the assumed arrangement. Rather, the method steps of the method disclosed herein result in the spatial position and orientation of a titanium profile 410, 410′, 410″, 410′″, after passing through the method, no longer corresponding to the spatial position that the glass body portion 400, 400′, 400″, 400′″ corresponding to the titanium profile had in the first glass body 300. Thus, the spatial orientation of the titanium profile 410, 410′, 410″, 410′″ changes such that a model is required to calculate the position and quantity of the TiO2 in the titanium apportionment 430 of the substrate precursor 900.

The calculated titanium apportionment 430 shown in FIG. 7b has a zigzag profile and thus deviates greatly from the desired parabolic titanium distribution 420.

In order to achieve an optimal arrangement, the possible arrangements of the glass body portions are permuted. In the model, the effects of all possible arrangements of the glass body portions on the titanium apportionment 430 are calculated. FIG. 8 is intended to illustrate this. The starting point is an arrangement, deviating from FIG. 7, of the four glass body portions 400, 400′, 400″, 400′″, which are joined together in the following arrangement to form the first glass component 600:

end side of the glass body portion 400″ is connected to the front face of the glass body portion 400′″ (point E2),

end side of the glass body portion 400′″ is connected to the front face of the glass body portion 400′ (point E3),

end side of the glass body portion 400′ is connected to the front face of the glass body portion 400 (point E4).

The model calculates a titanium apportionment 430′ in the substrate precursor 900 from the titanium profiles 410″, 410′″, 410′, 410. This titanium apportionment 430′ is more similar, both in quantity and in profile, to the desired titanium distribution 420 than the titanium apportionment 430 shown in FIG. 7b.

The model calculates in particular, from any possible arrangement of the glass body portions 400, 400′, 400″, 400′″, the corresponding titanium apportionment 430, 430′ and compares it to the desired titanium distribution 420. For this purpose, all possible arrangements of the glass body portions 400, 400′, 400″, 400′″ are permuted. Based on this information, the model in each case forms a difference between titanium apportionment and titanium distribution 420. The optimal arrangement is the arrangement in which the magnitude of the difference, in particular the maximum magnitude of the difference, between two spatially identical points on the substrate precursor is minimal.

Subsequently, the glass body portions 400, 400′, 400″, 400′″ are positioned and connected according to the optimal arrangement.

Analogously, at least one property distribution, in addition to the titanium distribution, can represent a second target value which is optimally fulfilled and/or sought in the substrate precursor 900. The model used in this variant is functionally dependent on

vv. an arrangement of the plurality of glass body portions 400, 400′, 400″, 400′″, relative to one another, in the first glass component 600,

ww. the spatial titanium profile 410, 410′, 410″, 410′″ and a spatial property profile 510 in each of the glass body portions 400, 400′, 400″, 400′″, and

xx. the effects of the step of pushing together and the step of turning on the spatial titanium profile 410, 410′, 410″, 410′″ and on the spatial property profile 510 in the glass body portions 400, 400′, 400″, 400′″.

Consequently, both the aspects relating to the element titanium dioxide and the aspects relating to at least one further property (e.g., ODC, Ti3+, etc.) are taken into account in the calculation of the optimal arrangement of the glass body portions.

Based on the solution space of possible arrangements of the glass body portions relative to

one another, a best possible arrangement of the glass body portions 400, 400′, 400″, 400′″ is determined. In this case, the aim is for the sum difference to be minimal, the sum difference comprising

i. the difference between titanium apportionment and titanium distribution, and

ii. the second difference between the at least one property apportionment and the at least one property distribution.

FIG. 9 shows a first homogenization treatment 1600 of the first glass component 600, which is created from the glass body portions 400″, 400′″, 400′, 400. Both the glass body and the first glass component 600 created from the glass body portions 400″, 400′″, 400′, 400 comprise microscopic, production-related layer structures. In order to reduce this and/or make it possible to produce a substrate precursor 900 substantially free of layer structures, two homogenization treatments are performed sequentially.

In the first homogenization treatment 1600, the first glass component 600 is clamped into a glass lathe 605 equipped with one or more burners 220 and is homogenized by means of a reshaping process, as described in EP 673 888 A1 for the purpose of complete removal of layer structures.

The glass lathe 605 has two chucks 610, 610′, which can be caused to rotate 650, 650′ independently of one another. The first glass component 600 is clamped between the two chucks 610, 610′. Two holding elements 620, 620′ can ensure a better fit between the chucks 610, 610′ and the first glass component 600. By means of the burner 220, the first glass component 600 is heated at points and softened in the process so that a shear zone 630 results. This shear zone 630 allows an external force, such as a torsional force, tensile or compressive force, to be introduced onto the rod-shaped first glass component 600. Within the shear zone 630, regions which have different stresses or experience different movements thus result, which is associated with a shear effect or expansion and compression effect. In order to generate this force, the two chucks 610, 610′ can rotate 650, 650′ in opposite directions in each case.

In the first homogenization treatment 1600, microscopic, production-related layer

structures in a plane of the shear zone of the first glass component 600 are effectively reduced. However, the reduction of microscopic, production-related layer structures perpendicular to the plane of the shear zone of the first glass component 600 is significantly less.

In order to eliminate the remaining residues of the layer structures in a second

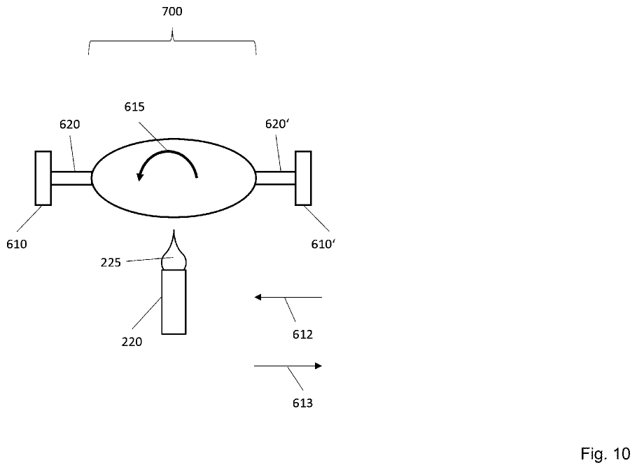

homogenization treatment 2000, the first glass component 600 must be reshaped. FIG. 10 illustrates pushing together 1700 the first glass component 600 to create a spherical glass system 700. For this purpose, the first glass component 600 is heated by means of the burner 220 and compressed. The pushing together 1700 can take place in that the two chucks 610, 610′ are moved toward one another, which is illustrated by the movement arrow 612. The glass system 700 is subsequently turned 1800 by more than 70 degrees. For this purpose, the glass system 700 is removed from the chucks 610, 610′ and rotated, which the movement arrow 615 is intended to illustrate. This rotation ensures that, in the second homogenization treatment 2000, the portion of the layer structure that was only slightly or not at all compensated in the first homogenization treatment 1600 can be effectively reduced. After the turning 1800 of the glass system 700 by more than 70 degrees, said system is again clamped into the chucks 610, 610′. This is followed by a stretching 1900 of the glass system 700. This mechanical reshaping of the spherical glass system 700 into an elongate second glass component 800 takes place by heating the glass system 700 using the burner 220, and moving the chucks 610, 610′ away from one another, which the movement arrow 613 illustrates.

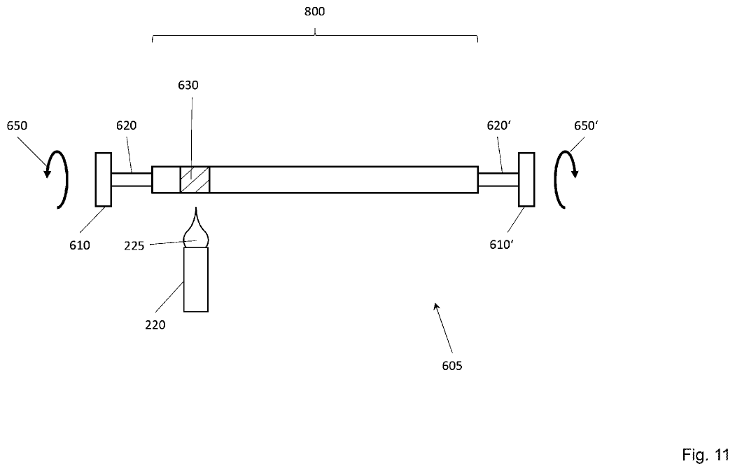

FIG. 11 illustrates a second homogenization treatment 2000 of the second glass component 800. The second homogenization treatment 2000 takes place substantially analogously to the first homogenization treatment 1600. The decisive difference is that, by means of the turning 1800, the layer structure that was previously substantially perpendicular to the longitudinal axis of the glass lathe 605 is now located in the direction of the longitudinal axis of the glass lathe 605. The second glass component 800 is clamped between the two chucks 610, 610′ of the glass lathe 605. By means of the burner 220, the second glass component 800 is heated at points and softened in the process so that a second shear zone 640 results. This second shear zone 640 allows an external force, such as a torsional force, tensile or compressive force, to be introduced onto the rod-shaped second glass component 800. In the second shear zone 640, regions which have different stresses or experience different movements thereby result, which is associated with a shear effect or expansion and compression effect. In order to generate this force, the two chucks 610, 610′ can rotate 650, 650′ in opposite directions in each case.

In this second homogenization treatment 2000, microscopic, production-related layer structures are effectively reduced in the direction perpendicular to the longitudinal axis of the first glass component 600 and/or in the direction of a longitudinal axis of the second glass component 800. After passing through both the first homogenization treatment 1600 and the second homogenization treatment 2000, a substrate precursor 900 results which is substantially free of layer structures.

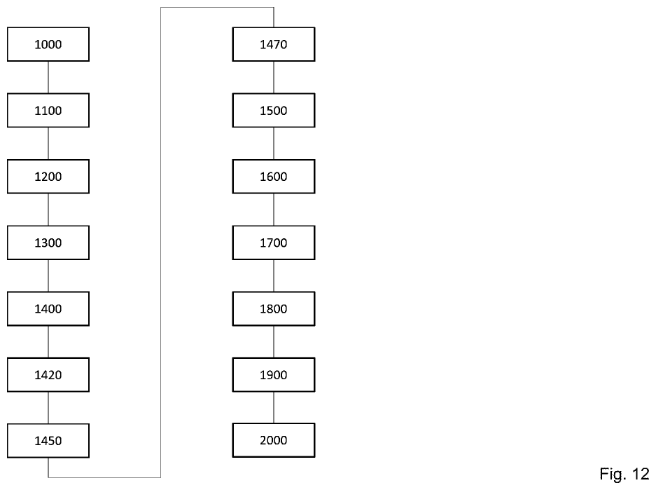

FIG. 12 shows a course of the method for producing a substrate precursor 900 having a mass of more than 100 kg, comprising a TiO2-SiO2 mixed glass. It comprises the steps of:

yy. introducing 1000 a silicon dioxide raw material and a titanium dioxide raw material into a flame,

zz. producing 1100 a glass body having a titanium dioxide content of 3 wt. % up to 10 wt. %, the glass body having:
i. a macroscopic, production-related titanium profile, and
ii. having a microscopic, production-related layer structure,
aaa. dividing 1200 the glass body into a plurality of rod-like glass body portions,
bbb. spatially measuring 1300 the titanium profile in each of the glass body portions,
ccc. connecting 1500 the glass body portions to form an elongate first glass component,
ddd. first homogenization treatment 1600 of the first glass component,
eee. pushing together 1700 the first glass component to create a spherical glass system,
fff. turning 1800 the glass system by more than 70 degrees,
ggg. stretching 1900 the glass system to form an elongate second glass component,
hhh. second homogenization treatment 2000 of the second glass component to create a substrate precursor 900, the substrate precursor 900 being substantially free of layer structures.

The method is characterized in that the step of measuring 1300 comprises the steps of:
iii. predetermining 1400 a desired spatial titanium distribution in the substrate precursor 900,
jjj. providing 1420 a model of a titanium apportionment in the substrate precursor 900, the model being dependent on

i. an arrangement of the plurality of glass body portions in the first glass component relative to one another,

ii. the spatial titanium profile in each of the glass body portions, and

iii. the effects of the step pf pushing together and the step of turning on the spatial titanium profiles in the glass body portions,
kkk calculating 1450 an optimal arrangement of the glass body portions relative to one another by means of the model so that a difference between titanium apportionment and titanium distribution is minimal,
lll. positioning 1470 the glass body portions so that, in the step of connecting, the glass body portions are connected according to the calculated optimal arrangement.

### Reference Signs

100 Apparatus
200 Soot body
210 Carrier tube
220 Burner or flame hydrolysis burner
225 Flame
250 Vitrification furnace
251 Movement arrow
300 Glass body
400, 400′, 400″ Glass body portion
401, 401′ Contact surface
410, 400′, 400″, 400′″ Titanium profile
420 Titanium distribution
430 Titanium apportionment
440 Longitudinal axis
510 Property profile
600 First glass component
605 Glass lathe
610, 610′ Chuck
612 Movement arrow
613 Movement arrow
615 Movement arrow
620, 620′ Two holding elements
630 Shear zone
640 Second shear zone
650, 650′ Rotation
700 Spherical glass system
800 Second glass component
900 Substrate precursor
910 Outer surface
920 Centerline
1000 Introducing
1100 Producing
1200 Dividing
1300 Spatially measuring
1400 Predetermining
1420 Providing a model
1450 Calculating an optimal arrangement
1470 Positioning the glass body portions
1500 Connecting the glass body portions
1600 First homogenization treatment
1700 Pushing together
1800 Turning the glass system
1900 Stretching
2000 Second homogenization treatment

1. A method for producing a substrate precursor having a mass of more than 50 kg, comprising a TiO2-SiO2 mixed glass, comprising the steps of:
introducing a silicon dioxide raw material and a titanium dioxide raw material into a flame,
producing a glass body having a titanium dioxide content of 3 wt. % up to 10 wt. %, the glass body comprising:
a macroscopic, production-related titanium profile, and
a microscopic, production-related layer structure,
dividing the glass body into a plurality of rod-like glass body portions,
spatially measuring the titanium profile in each of the glass body portions,
connecting the glass body portions to form an elongate first glass component,
first homogenization treatment of the first glass component,
pushing together the first glass component to create a spherical glass system,
turning the glass system by more than 70 degrees,
stretching the glass system to form an elongate second glass component,
second homogenization treatment of the second glass component to create a substrate precursor, the substrate precursor being substantially free of layer structures, wherein the step of measuring comprises the following steps of:
predetermining a desired spatial titanium distribution in the substrate precursor,
providing a model of a titanium apportionment in the substrate precursor, the model being dependent on
an arrangement of the plurality of glass body portions in the first glass component relative to one another,
the spatial titanium profile in each of the glass body portions, and
the effects of the step of pushing together and the step of turning on the spatial titanium profiles in the glass body portions,
calculating an optimal arrangement of the glass body portions relative to one another by means of the model so that a difference between the titanium apportionment and titanium distribution is minimal,
positioning the glass body portions so that, in the step of connecting, the glass body portions are connected according to the calculated optimal arrangement.

2. The method according to claim 1, wherein the substrate precursor has a mass of more than 100 kg, in particular more than 200 kg, in particular more than 300 kg.

3. The method according to claim 1, wherein the method comprises the following step of:
producing a second glass body having a titanium dioxide content of 3 wt. % up to 10 wt. %, the second glass body comprising:
a second, macroscopic, production-related titanium profile, and
a second, microscopic, production-related layer structure,
dividing the second glass body into a plurality of rod-like glass body portions.

4. The method according to claim 1, wherein at least three, in particular at least five, in particular at least eight, glass body portions are connected to form the first glass component.

5. The method according to claim 1, wherein the difference between the titanium apportionment and titanium distribution is less than 1.5% based on a maximum value of the titanium distribution, in particular less than 1.0%, in particular less than 0.5%.

6. The method according to claim 1, wherein the glass body comprises at least one of the following property profiles:
a macroscopic, production-related OH profile,
a macroscopic, production-related CTE profile,
a macroscopic, production-related fluorine profile,
a macroscopic, production-related bubble profile,
a macroscopic, production-related ODC profile,
a macroscopic, production-related Ti3+ profile,
a macroscopic, production-related profile of metallic impurities.

7. The method according to claim 6, wherein, in the step of measuring, at least one of the property profiles is measured in each of the glass body portions.

8. The method according to claim 7, wherein the step of measuring comprises the following steps of:
predetermining a desired spatial property distribution in the substrate precursor,
providing a model of a property apportionment in the substrate precursor, the model being dependent on
an arrangement of the plurality of glass body portions in the first glass component relative to one another,
a spatial property profile in each of the glass body portions, and
the effects of the step of pushing together and the step of turning on the spatial property profile in the glass body portions,
calculating a best possible arrangement of the glass body portions relative to one another by means of the model so that a sum difference is minimal, the sum difference comprising
the difference between the titanium apportionment and titanium distribution, and
the second difference between the property apportionment and property distribution,
positioning the glass body portions so that, in the step of connecting, the glass body portions are connected according to the calculated best possible arrangement.

9. The method according to claim 8, wherein the sum difference is less than 1.5% based on a sum of a maximum value of the titanium distribution and a maximum value of the property distribution, in particular less than 1.0%, in particular less than 0.5%.

10. The method according to claim 1, wherein the step of producing the glass body comprises at least the following steps of:
creating a porous soot body, the macroscopic, production-related titanium profile extending substantially along a longitudinal axis, and the microscopic, process-related layer structure extending substantially along a growth axis,
vitrifying the soot body to create the cylindrical glass body.

11. The method according to claim 1, wherein the first glass component is heated before the step of pushing together.

12. The method according to claim 1, wherein the connection takes place at a relevant contact surface of the glass body portions.
